(19) United States
(12) Patent Application Publication
(10) Pub. No.: US 2019/0169823 A1
(43) Pub. Date: Jun. 6, 2019

(54) Faucet Insulator

(71) Applicant: Rose Elizabeth Modica, Shrevport, LA (US)

(72) Inventor: Rose Elizabeth Modica, Shrevport, LA (US)

(21) Appl. No.: 16/000,856

(22) Filed: Jun. 5, 2018

Related U.S. Application Data
(60) Provisional application No. 62/603,561, filed on Jun. 5, 2017.

(51) Int. Cl. E03B 9/02; F16K 27/12

(52) U.S. Cl. CPC E03B 9/027; F16K 27/12

(57) ABSTRACT

The faucet insulator apparatus is a device which enables one to help protect a faucet and by extension connected pipes from cold weather elements. The product is a significant improvement over other solution in that it is quick and easy to install. The invention is comprised of an insulation region and a capturing recess which provide a form fitting system for a variety of outdoor faucets.

### CROSS REFERENCE TO RELATED APPLICATIONS

This application claims priority to U.S. provisional application 62/603,561 filed on Jun. 5, 2017, titled ‘Faucet Insulator_{—} commonly invented and owned by the present inventor.

### FIELD OF THE INVENTION

The disclosure as detailed herein is in the technical field of insulation material. Moreover, this is in the field of insulator covers. Moreover, this is in the field of faucet insulator covers.

### BACKGROUND OF THE INVENTION

Exterior faucets are commonly identified as susceptible to freezing. When the weather drops below freezing it may cause great damage on a home's plumbing if the plumbing is not protected. Current products on the market for protecting faucets are difficult to use and time consuming to install. These covers are especially difficult to quickly install when the weather conditions change suddenly.

For example, U.S. Pat. No. 5,878,776, titled ‘Insulating Jacket,_{—} issued Mar. 9, 1999 to Love, teaches an insulating jacket for covering and insulating an exterior faucet against cold weather. The insulating jacket teaches using three plastic bags arranged concentrically and all opening in one direction. The invention is a fabric sock that is secured to the faucet using a draw cord. Unfortunately, the invention is deficient in that it uses a draw cord in its construction. A draw cord would require the user to remain in the inclement weather while the user attempts to properly fit the device on the faucet. Therefore, the device is not desirable because it increases the time the user would need to install the device.

Another faucet cover typical of conventional covers is taught by U.S. Pat. No. 9,261,203 (the ‘'203 Patent_), titled ‘Inflatable Faucet Insulation_{—} issued Feb. 16, 2016 to Vulpitta. The :203 Patent teaches a faucet cover having several inflatable layers. However, just as with the prior art described above, the invention disclosed in the :203 patent is inconvenient and time consuming to install. The devices air chambers must be inflated before use.

What is needed is an apparatus for protecting a faucet that may install in seconds compared to existing ones on the market. This would protect pipes without taking away the integrity of the insulator.

This can prevent pipes from being broken and costly damages and repairs. This would be more effective for homeowners in colder geographical climates. Further, this would be ideal for people with physical limitations with their hands. Purchasers would no longer be required to stand in the harsh winter conditions for long periods of time trying to install conventional faucet covers or have to attempt a do-it-yourself solution.

### BRIEF SUMMARY OF THE INVENTION

The faucet insulator apparatus is a device which enables one to help protect a faucet and by extension connected pipes from cold weather elements. The product is a significant improvement over other solutions in that it is quick and easy to install. The invention is comprised of an insulation region and a capturing recess which provide a form fitting system for a variety of outdoor faucets.

In some embodiments, the faucet insulation apparatus comprises an insulation region, and a capturing recess. In some embodiments, said insulation region is adapted to conform to a faucet. In some embodiments, said insulation region shape is cylindrical.

In some embodiments, said capturing recess is circular shaped. In some embodiments, said insulation region is positioned to surround said capturing recess. In some embodiments, said capturing recess is positioned within said insulation region.

In some embodiments, said capturing recess is positioned surrounding said faucet. In some embodiments, said capturing recess is adapted to surround and grasp said faucet. In some embodiments, said capturing recess has a minimum diameter of 2 inches and a maximum diameter of 4 inches. By ‘grasp,_{—} what may be meant is that the capturing recess encircles the faucet. In this instance, grasping does not mean to hold with close engagement. Here, grasping means that the capturing recess encircles the faucet only to the inside diameter of the capturing recess.

In some embodiments, said insulation region has a minimum diameter of 4 inches and a maximum diameter of 8 inches. In some embodiments, said insulation region comprises a circular insulation region, a base region, and a top region. In some embodiments, said circular insulation region is adapted to mediate the insulating effects on said faucet.

In some embodiments, said circular insulation region is positioned outside said capturing recess. In some embodiments, said base region is positioned below said circular insulation region. In some embodiments, said base region is positioned below said circular insulation region.

In some embodiments, said circular insulation region has a minimum length of 4 inches and a maximum length of 8 inches. In some embodiments, said circular insulation region has a minimum thickness of 0.5 inches and a maximum thickness of 1.5 inches. In some embodiments, said base region comprises a base, and a base edge. In some embodiments, said base region is positioned below said circular insulation region.

In some embodiments, wherein said insulation region is made of polyurethane. In some embodiments, said insulation region is made of at least one of closed-cell foam, ethelyne-vinyl acetate, polyethylene, polystyrene, fiber glass, foil insulation, mineral wool, cellulose, polyisocyanurate, or natural fibers.

### DESCRIPTION OF FIGURES

FIG. 1 is a perspective view, which shows the faucet insulator apparatus with the functional regions annotated.

FIG. 2 is a top-down view of the inside of the faucet insulation apparatus showing the capturing recess for receiving the faucet.

FIG. 3 is a bottom-up view of the bottom of the faucet insulator apparatus.

FIG. 4 is a perspective side view of the bottom of the faucet insulator apparatus showing the base region and its subcomponents.

FIG. 5 is a perspective side view of the top of the faucet insulator apparatus showing the capturing recess and its visible related components.

FIG. 6 is a diagram of overall use of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way.

One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described.

The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way. When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

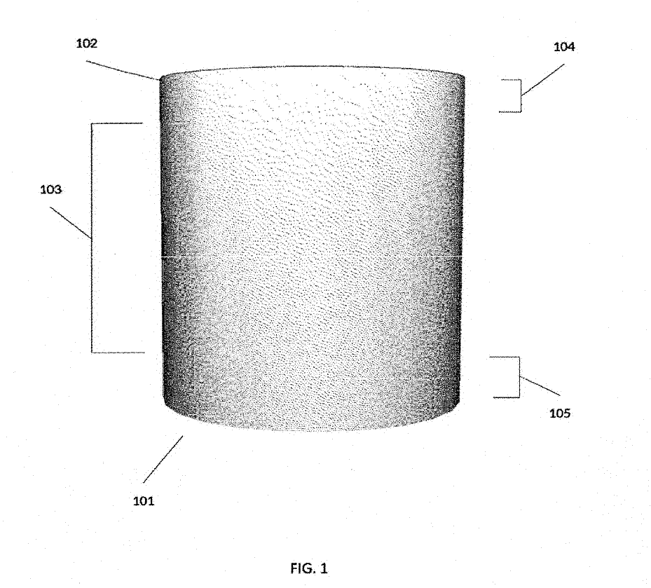

Referring now to FIG. 1, which shows a perspective view of the faucet insulator apparatus with the functional regions annotated. In some embodiments, faucet insulator apparatus 101 comprises capturing recess 201 and insulation region 102. In some embodiments, insulation region 102 comprises is the general insulating component which houses and insulates a faucet when covered. A faucet is a device by which a flow of liquid or gas from a pipe or container can be controlled.

Insulation region 102 interacts with the faucet by covering it and shielding it from outdoor elements and freezing conditions. Spatially, insulation region 102 is preferably positioned surrounding the capturing recess 201. Insulation region 102 is preferably shaped like a cylinder.

Insulation region 102 is mainly thought to be composed of polyurethane, however other embodiments may be composed of any one of the following: closed-cell foam, ethylene-vinyl acetate, polyethylene, polystyrene, fiberglass, foil insulation, mineral wool, cellulose, polyisocyanurate, or natural fibers.

In some embodiments, insulation region 102 has a preferred diameter of 4.125 inches but in some embodiments, may range from a minimum of 3 inches to a maximum diameter of 8 inches. In some embodiments, the diameter of insulation region 102 can be calculated by first determining the size of the faucet that the apparatus 101 is attached to. In some embodiments, Insulation region 102 preferably comprises circular insulation region 103, base region 105, and finally top region 104.

In some embodiments, circular insulation region 103 is the middle region of the insulation region 102 (which in turn holds a majority of the insulation material for the faucet). Spatially, circular insulation region 103 is preferably positioned outside the capturing recess 201. In some embodiments, circular insulation region 103 has a preferred thickness of 0.75 inches but in some embodiments, may range from a minimum of 0.5 inches to a maximum thickness of 1.5 inches.

In some embodiments, circular insulation region 103 has a preferred length of 5 inches but in some embodiments, may range from a minimum of 4 inches to a maximum length of 8 inches. The circular insulation region 103 is adapted to mediate the insulation of the faucet. In some embodiments, circular insulation region 103 comprises insulation 202 and outside wall 203.

In some embodiments, top region 104 is a secure opening that fits around the bottom of a faucet. In some embodiments, base region 105 is a flat area of the insulation region 102 which encloses the faucet insulator apparatus 101 and which ensures that the faucet is protected from cold and other elements. Spatially, base region 105 is preferably positioned below the circular insulation region 103. Base region 105 comprises edge 301 and base 204.

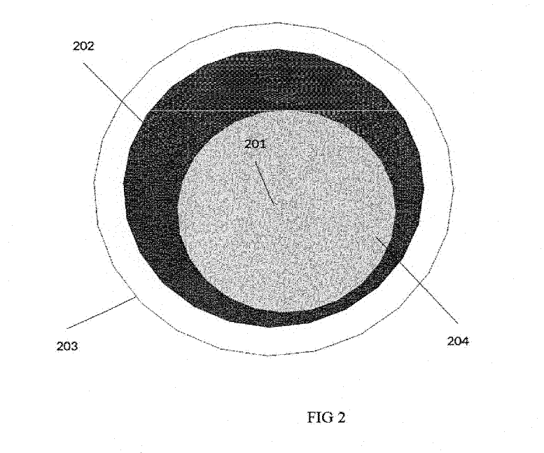

Referring now to FIG. 2, which shows top-down view of the inside of the faucet insulation apparatus showing the capturing recess for receiving the faucet. In some embodiments, capturing recess 201 is a secure fitting interior region that surrounds and deforms to protect the faucet. Capturing recess 201 interacts with the faucet by deforming to grasp the faucet and adhere to it via gravity and/or friction force.

Spatially, capturing recess 201 is preferably positioned surrounding the faucet and within the insulation region 102. Capturing recess 201 is preferably shaped like a circle however, it is thought that in alternative embodiments that it may also be shaped like square. In some embodiments, capturing recess 201 has a preferred diameter of 2.625 inches but in some embodiments, may range from a minimum of 2 inches to a maximum diameter of 4 inches.

In some embodiments, capturing recess 201 comprises inside wall 501 and inside aperture. Outside wall 203 is the outer surface which encases the insulation 202 in the insulation region 102. Outside wall 203 is preferably shaped like a cylinder however, it is thought that in alternative embodiments that it may also be shaped like square.

Base 204 is the external area that covers the entire end of the insulation region 102. Base 204 is preferably shaped like circle. Base 204 is mainly thought to be composed of polyurethane. In some embodiments, base 204 has a preferred diameter of 4.125 inches but in some embodiments, may range from a minimum of 3 inches to a maximum diameter of 8 inches. One goal of base 204 is to seal the opening for the insulation 202.

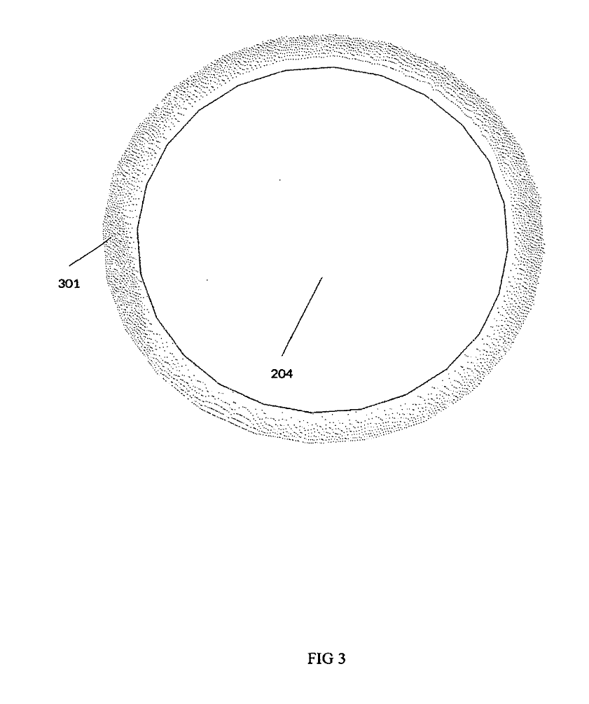

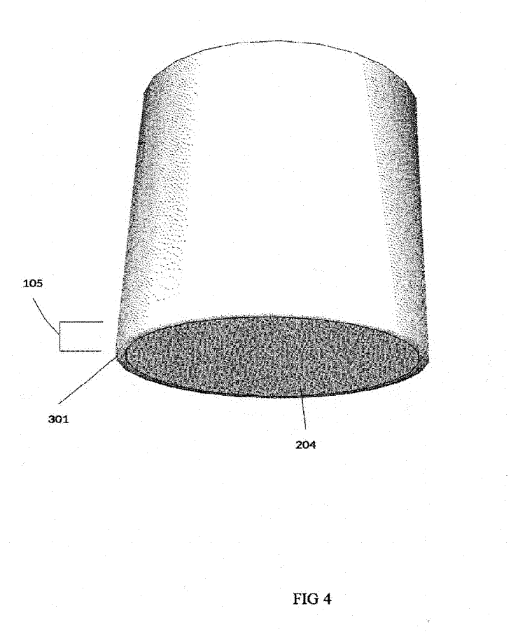

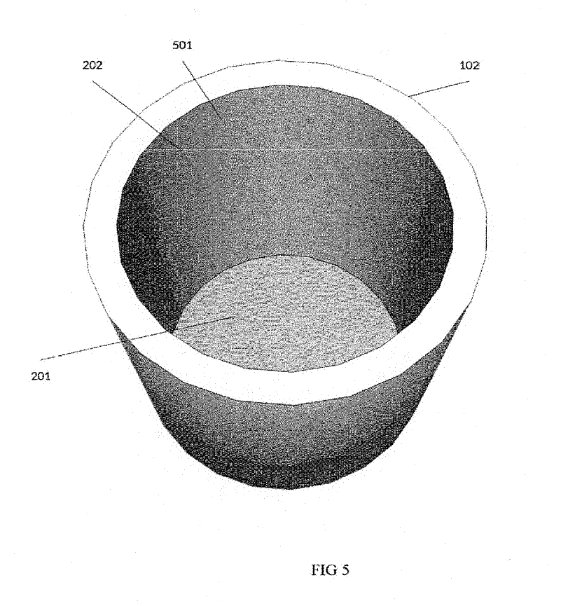

Referring now to FIGS. 3, 4 and 5, which shows I) a bottom-up view of the bottom of the faucet insulator apparatus, II) a perspective side view of the bottom of the faucet insulator apparatus showing the base region and its subcomponents. III) a perspective side view of the top of the faucet insulator apparatus showing the capturing recess and its visible related components.

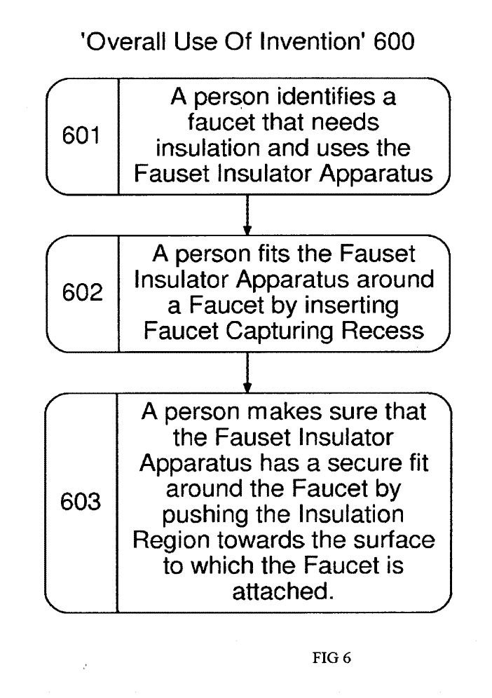

Referring now to FIG. 6, which shows overall use of the invention. In a first step, a person identifies a faucet that needs insulation and uses the faucet insulator apparatus 101 (Step 601). Next, a person fits the faucet insulator apparatus 101 around a faucet by inserting faucet capturing recess 201 (Step 602). Next, a person makes sure that the faucet insulator apparatus 101 has a secure fit around the faucet by pushing the insulation region 102 towards the surface to which the faucet is attached. (Step 603).

I claim:

1. A faucet insulation apparatus comprising:
an insulation region, and a capturing recess;
wherein said insulation region is adapted to conform to a faucet;
wherein said insulation region shape is cylindrical;
wherein said capturing recess is shape is circular;
wherein said insulation region is positioned to surround said capturing recess;
wherein said capturing recess is positioned within said insulation region;
wherein said capturing recess is positioned surrounding said faucet;
wherein said capturing recess is adapted to surround and grasp said faucet.

2. The apparatus of claim 1 wherein said capturing recess has a minimum diameter of 1 inch and a maximum diameter of 4 inches.

3. The apparatus of claim 2 wherein said insulation region has a minimum diameter of 3 inches and a maximum diameter of 8 inches.

4. A faucet insulation apparatus comprising:
an insulation region, and a capturing recess;
wherein said insulation region is adapted to conform to a faucet;
wherein said insulation region shape is cylindrical;
wherein said capturing recess is shape is circular;
wherein said insulation region is positioned to surround said capturing recess;
wherein said capturing recess is positioned within said insulation region;
wherein said capturing recess is positioned surrounding said faucet;
wherein said capturing recess is adapted to surround and grasp said faucet;
wherein said capturing recess has a minimum diameter of 2 inches and a maximum diameter of 4 inches;
wherein said insulation region has a minimum diameter of 3 inches and a maximum diameter of 8 inches.

5. The apparatus of claim 4 wherein said insulation region comprises a circular insulation region, a base region, and a top region.

6. The apparatus of claim 5 wherein said circular insulation region is adapted to mediate the insulating effects on said faucet.

7. The apparatus of claim 6 wherein said circular insulation region is positioned outside said capturing recess.

8. The apparatus of claim 7 wherein said base region is positioned below said circular insulation region.

9. A faucet insulation apparatus comprising:
an insulation region, and a capturing recess;
wherein said insulation region is adapted to conform to a faucet;
wherein said insulation region shape is cylindrical;
wherein said capturing recess is shape is circular;
wherein said insulation region is positioned to surround said capturing recess;
wherein said capturing recess is positioned within said insulation region;
wherein said capturing recess is positioned surrounding said faucet;
wherein said capturing recess is adapted to surround and grasp said faucet;
wherein said capturing recess has a minimum diameter of 2 inches and a maximum diameter of 4 inches;
wherein said insulation region has a minimum diameter of 3 inches and a maximum diameter of 8 inches;
wherein said insulation region comprises a circular insulation region, a base region, and a top region;
wherein said circular insulation region is adapted to mediate the insulating effects on said faucet;
wherein said circular insulation region is positioned outside said capturing recess;
wherein said base region is positioned below said circular insulation region.

10. The apparatus of claim 9 wherein said base region is positioned below said circular insulation region.

11. The apparatus of claim 10 wherein said circular insulation region has a minimum length of 4 inches and a maximum length of 8 inches.

12. The apparatus of claim 11 wherein said circular insulation region has a minimum thickness of 0.5 inches and a maximum thickness of 1.5 inches.

13. The apparatus of claim 12 wherein said base region comprises a base, and a base edge.

14. The apparatus of claim 13 wherein said base region is positioned below said circular insulation region.

15. The apparatus of claim 14 wherein said insulation region is made of polyurethane.

16. The apparatus of claim 14 wherein said insulation region is made of ethelyne-vinyl acetate.

17. The apparatus of claim 14 wherein said insulation region is made of closed-cell foam.

18. The apparatus of claim 14 wherein said insulation region is made of polyethylene.

19. The apparatus of claim 14 wherein said insulation region is made of foil insulation

20. The apparatus of claim 14 wherein said insulation region is made of at least one of foil, insulation, fiberglass, polystyrene, mineral wool, cellulose, polyisocyanurate or natural fibers.
